(19) United States
(12) Patent Application Publication
(10) Pub. No.: US 2007/0190221 A1
(43) Pub. Date: Aug. 16, 2007

(54) METHOD AND APPARATUSES FOR HEALTHY RICE COOKING AND REMOVING STARCH IN RICE

(75) Inventor: Tung Hoi Tse, Wanchai (HK)

Correspondence Address: NIXON & VANDERHYE, PC, 901 NORTH GLEBE ROAD, 11TH FLOOR, ARLINGTON, VA, 22203, US

(73) Assignee: PENSONIC (H.K.) Corporation Limited, Wanchia (HK)

(21) Appl. No.: 11/627,689

(22) Filed: Jan. 26, 2007

(30) Foreign Application Priority Data
Jan. 27, 2006 (HK) 200610002283.9

(51) Int. Cl. A23L 1/00

(52) U.S. Cl. 426/618

(57) ABSTRACT

Method and apparatuses for healthy rice cooking and removing starch in rice is disclosed. There is provided a rice cooker, including an inner pot, an outer case with control buttons, power input terminal, a thermostat component, a control circuit, a rice cooker lid and a heater plate. The inner pot is placed inside the outer case; the heating plate, the thermostat and the control circuit are placed at the bottom of the inner pot. A starch removing device is placed between the bottom of the inner pot and the outer case, the starch removing device comprises: a heating plate, power input terminal, a thermostat component, a control circuit disposed at the bottom, a medium case inside the outer case, a water storage trough at the exterior of the medium case, a water drainage trough between the medium case and the outer case, and a evaporating tube at the bottom of the water storage trough; the ends of the evaporating tube is connected with the water storage trough and the inner pot through channels, the water drainage trough is connected with a valve and the bottom of the inner pot through channels. With the use of the rice cooker, the rice can be soaked and cleansed with flowing water before rice cooking. This process removes a portion of starch in rice, thus lowers the starch content in rice and benefits human health.

### BACKGROUND OF THE INVENTION

This application claims priority to Chinese (PRC) Patent Application number 200610002283.9, filed on 27 Jan. 2006, the disclosures of which are hereby incorporated herein by reference.

The present invention relates generally to a method for removing starch in rice and a cooking device making use thereof, in particular, a healthy rice cooker for cooking rice and a portion of starch in rice can be removed by the healthy rice cooker before cooking the rice.

Nowadays, the most common device for cooking rice is rice cooker. The operation procedure of a conventional rice cooker is putting cleansed rice into the inner pot inside the rice cooker, plugging the rice cooker to a power supply, pushing the switch to initiate the rice-cooking state, automatically cutting off the power supply after the rice is cooked, maintaining temperature by auxiliary heating components until the power is unplugged. The use of conventional rice cooker is safe and convenient, making it popular among most consumers. However, the conventional rice cooker can only cook rice but cannot remove a portion of starch in rice. Carbohydrates such as starch is one of the factors which make people become obese. According to medical proofs, taking excess carbohydrates affects the health of people.

### BRIEF DESCRIPTION OF THE INVENTION

Method and apparatuses for rice cooking and removing starch in rice is disclosed. There is provided a rice cooker, including an inner pot, an outer case with control buttons, a thermostat, a control circuit, a rice cooker lid and a heater plate. The inner pot is placed inside the outer case; the heating plate, the thermostat and the control circuit are placed at the bottom of the inner pot.

A starch removing device is placed between the bottom of the inner pot and the outer case, the starch removing device comprises: a heating plate, a thermostat, a control circuit disposed at the bottom, a medium case inside the outer case, a water storage trough at the exterior of the medium case, a water drainage trough between the medium case and the outer case, and a evaporating tube at the bottom of the medium case; the evaporating tube is connected with the water storage trough and the inner pot through channels, the water drainage trough is connected with a electromagnetic valve and the bottom of the inner pot through channels. With the use of the rice cooker, the rice can be soaked and cleansed with flowing water before rice cooking. This process removes a portion of starch in rice, thus lowers the starch content in rice and benefits human health.

The removal of a portion of starch in cooked rice is desirable to enhance the cooked rice. A novel rice cooker has been developed that removes a portion of starch in rice. A novel method has also been developed to remove a portion of starch in rice by the rice cooker.

The method for removing a portion of starch in rice according to an embodiment of the present invention comprises the following steps: (1) rice is soaked in hot water of 80˜90° C.; as rice swells after being soaked in hot water, water molecules enter into the rice and dissolve the amylase therein; in the meantime, the hot water gelatinizes the amylopectin in the rice; (2) after being soaked, the rice is cleansed with flowing water; and (3) steps 1) and 2) are repeated to carry away a portion of starch in rice.

The rice cooker according to one embodiment of the present invention comprises: an inner pot, an outer case with control buttons, power input terminal, a thermostat component, a control circuit, a rice cooker lid and a heating plate; the inner pot is placed inside the outer case; the heating plate, the thermostat and the control circuit are installed at the bottom of the inner pot; a starch removing device is installed between the bottom of the inner pot and the outer case.

In another embodiment, the starch removing device comprises: a heating plate, power input terminal, a thermostat component, a control circuit disposed at the bottom, a medium case inside the outer case, a water storage trough at the exterior of the medium case, a water drainage trough between the medium case and the outer case, and a evaporating tube at the bottom of the water storage trough; both ends of the evaporating tube are connected with the water storage trough and the inner pot through channels, the water drainage trough is connected with a the bottom of the inner pot through channels and valve.

A support for holding the heating tube, the water channel is installed between the top of the water drainage trough and the bottom of the medium case.

The valve is controlled by the control circuit and electromagnet in the support.

The evaporating tube comprises an aluminum water channel and a heating tube which applies heat to the aluminum water channel, wherein an end of the aluminum water channel passes through a cold water channel, one-way valve and water storage trough; the other end of the aluminum water channel is connected with a hot water channel and the top of the inner pot; the evaporating tube has a thermostat installed at the bottom. The heating tube and the aluminum water channel are arranged laterally. The aluminum water channel is arranged inside the heating tube. A bottom case of the inner pot for installing securely the heating plate, the power input terminal, the thermostat component and the control circuit are arranged inside the medium case.

A thermal insulating ceramic pad is arranged between the bottom case of the inner pot and the heating plate.

A method of removing starch using rice cooker according to an embodiment of the invention comprises the following steps: (1) rice in the inner pot of a rice cooker is soaked in hot water generated by the starch removing device of the rice cooker; as the rice swells after being soaked, water molecules enter into the rice and dissolve the amylase therein; in the meantime, the hot water gelatinizes the amylopectin in the rice; (2) after being soaked, the rice is cleansed with flowing water; and (3) repeat steps 1) and 2) to carry away a portion of starch in rice. By the addition of a starch removing device, the rice cooker of the present invention can soak the rice and cleanse the rice with flowing water before cooking the rice. This can remove portion of starch in rice, thus reducing the starch content in rice which is beneficial to health.

### BRIEF DESCRIPTION OF THE DRAWINGS

FIGS. 1 and 2 show an embodiment of a rice cooker.

### DETAILED DESCRIPTION OF THE INVENTION

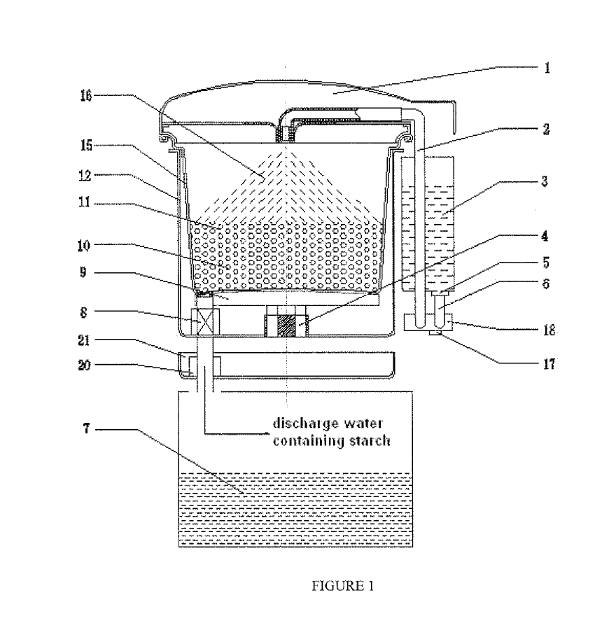

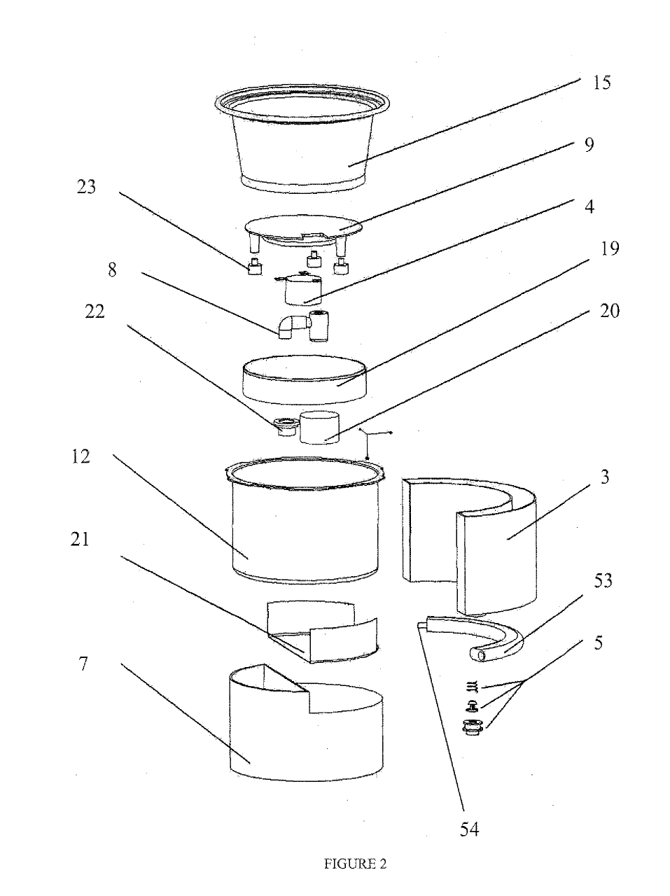

As shown in FIGS. 1 and 2, the healthy rice cooker of the present invention comprises: an outer case with buttons (not shown in drawings), an inner pot 15, a rice cooker lid 1, a heating plate 9, a thermostat and power input terminal 4, and a control circuit; the structures and the functions of the inner pot 15 and the outer case are the same as those of conventional rice cookers, for example, the rice cooker of the present invention provide same functions like cooking rice and congee as conventional rice cookers. Moreover, the control circuit is simple and conventional technology which can be implemented easily by a skilled person in the art, hence no further description is required. The difference between the rice cooker of the present invention and conventional rice cookers is the incorporation of a starch removing device.

The starch removing device comprises: a medium case 12 placed between the inner pot 15 and the outer case, a water storage trough 3 at the outer side of the medium case 12, a water drainage trough 7 at the bottom; the water drainage trough 7 is connected with the outer case to form a drawer structure which is in a detachable manner to facilitate the removal of water from the water drainage trough 7, this is not further described because a skilled person in the art can easily implement such structure which is part of the prior art. A support 21 for holding the heating tube 53 is placed between the water drainage trough 7 and the outer bottom of the medium case 12, the heating tube 53 comprises an aluminum water channel 54 within and a heating tube 53 for heating the aluminum water channel 54. One end of the aluminum water channel 54 is connected with the water storage trough 3 through a cold water channel 6 and a one-way valve 5, the other end extends into the rice cooker lid 2 through a hot water channel 2 and connects to the top of the inner case 15, allowing the water heated up by the evaporating tube 18 to enter the inner pot 15. The evaporating tube 18 has a thermostat 17 installed at the bottom for controlling the temperature of the evaporating tube 18. As shown in FIG. 2, the aluminum water channel 54 is embedded in the heating tube 53. The aluminum water channel 54 can be arranged with the heating tube 53 laterally. The water drainage trough 7 is connected with the bottom of the inner pot 1 through the valve 8 and water drainage 22, wherein valve 8 is controlled by the electromagnet 20 and control circuit arranged in the support 21; in order to further separate the electromagnetic valve 8 from the heating plate 9, the thermostat 4, power input terminal and the control circuit, a bottom case 19 of the inner pot is installed within the medium case 12, and the position is fixed by a ceramic thermal insulating pad 23 between the bottom case 19 of the inner pot and the heating plate 9.

FIG. 2 shows the rice cooker according to an embodiment of the invention being in used. Clean water is filled in the water storage trough 3 first, and rice is poured into the inner pot 15. The power supply is then plugged and the appropriate function is selected on the operation panel. After confirming, the heating tube 53 in the evaporating tube 18 begins to heat. The water inside the aluminum water channel 54 which is arranged laterally with the heating tube 53 is heated and evaporated. Steam 16 enters into the inner pot 15 from the top of the inner pot 15 through the hot water channel 2 and the rice cooker lid 1. Steam then cools down and becomes hot water of 80˜90° C., and soaks the rice 10 in the inner pot 15. In the meantime, a negative pressure is formed inside the aluminum water channel 54 because of the discharge of the steam. Under the negative pressure, water in the water storage trough 3 automatically refills into the aluminum water channel 54 through the cold water channel 6 and the one-way valve 5. This happens until the power is cut off from the heating tube 53 and the rice cooker enters into the temperature maintenance state. After several minutes, discharge of water starts, the soaked rice is cleansed with flowing water. The heating tube 53 begins to heat again after cleansing is complete, making steam flow into the inner pot 15 again. Water is again discharged. This cycle is repeated for several times until the water in the water storage trough 3 is completely evaporated and directed into the inner pot 15. The control circuit control the heating plate 9 to start working and cook the rice. Finally, the thermostat 4 breaks the circuit of the heating plate and the rice cooker enters into temperature maintenance state until the power is unplugged.

The method of removing starch in accordance with another embodiment of the present invention can be implemented without using the rice cooker described above. Instead, it can be done by directly soaking the rice in hot water of 80˜90° C. The principle for removing starch is based on the fact that approximately 75% of the composition of rice is starch. The starch in rice can be classified into two types: amylose and amylopectin. Amylose can dissolve in water directly whereas amylopectin is insoluble in water but can be gelatinized after being heated. The rice cooker according to an embodiment of the present invention injects steam into the inner pot during rice cooking process and soaks the rice in hot water for several minutes to make the rice swell, water molecules can enter the rice and hence dissolve part of the amylose, as well as to gelatinize part of the amylopectin. Then the discharge of hot water carries away the portion of starch which is dissolved and gelatinized in water. After many times of hot water soaking and cleansing, a portion of starch can be removed. According to measurement, 10% of starch in every 100 gm of rice can be removed after many times of soaking and cleansing. The starch content in rice is thus reduced and turns out to benefit human health without affecting the texture of rice.

The embodiments and arrangements described hereinafter are applicable to electrical appliances, consumer electronics and rice cooker industries, amongst others. The foregoing describes only a few embodiments of the present invention, and modifications and/or substitutions can be made thereto without departing from the scope and spirit of the invention, the embodiments being illustrative and not restrictive.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method for removing starch in rice comprising:
a) soaking the rice in hot water of 80˜90° C.; as rice swells after being soaked in hot water, water molecules enter into the rice and dissolve the amylase therein; in the meantime, the hot water gelatinizes the amylopectin in the rice;
b) cleansing the rice with flowing water after soaking, and
c) repeating steps a) and b) to remove a portion of the starch in rice.

2. A healthy rice cooker comprising:
an inner pot;
an outer case with control buttons, wherein said inner pot is placed inside said outer case;
a starch removing device installed between the bottom of said inner pot and said outer case;
a power input terminal;
a thermostat component;
a control circuit;
a heating plate;
said heating plate, said thermostat, and said control circuit are placed at the bottom of said inner pot, and
a rice cooker lid.

3. A rice cooker according to claim 2, wherein said starch removing device comprises:
a medium case placed inside said outer case at the bottom of said heating plate, said power input terminal, said thermostat component and said control circuit;
a water storage trough placed at the exterior of said medium case;
a water drainage trough placed between said medium case and said outer case; said water drainage trough is connected with the bottom of said inner pot through channels and a valve; and
an evaporating tube placed at the bottom of said water storage trough, wherein both ends of said evaporating tube are connected with said water storage trough and said inner pot through channels.

4. A healthy rice cooker according to claim 3, further comprising a support arranged between the top of said water drainage trough and the bottom of said medium case for holding said heating tube.

5. A healthy rice cooker according to claim 3, wherein:
said valve is controlled by said control circuit and a electromagnet inside said support.

6. A healthy rice cooker according to claim 3, wherein:
said evaporating tube comprises an aluminum water channel and a heating tube which applies heat to said aluminum water channel, wherein an end of said aluminum water channel passes through a cold water channel, a one-way valve and said water storage trough;
another end of said aluminum water channel is connected to the top of said inner pot through a hot water channel; and
the evaporating tube has a thermostat installed at the bottom.

7. A healthy rice cooker according to claim 6, wherein said heating tube and said aluminum water channel are arranged laterally.

8. A healthy rice cooker according to claim 6, wherein said aluminum water channel is placed inside said heating tube.

9. A healthy rice cooker according to claim 2, further comprising a bottom case of said inner pot arranged inside said medium case for housing said heating plate, said power input terminal, said thermostat component and said control circuit.

10. A healthy rice cooker according to claim 9, further comprising a thermal insulating ceramic pad arranged between said bottom case of said inner pot and said heating plate.

11. A method of removing starch using the healthy rice cooker of claim 2 comprising:
a) soaking the rice in said inner pot of said rice cooker in hot water generated by said starch removing device of said rice cooker; as rice swells after being soaked in hot water, water molecules enter into the rice and dissolve the amylase therein; in the meantime, the hot water gelatinizes the amylopectin in the rice;
b) cleansing the rice with flowing water after being soaked; and
c) repeating steps 1) and 2) to remove a portion of starch in rice.
